(19) United States
(12) Patent Application Publication
(10) Pub. No.: US 2010/0216506 A1
(43) Pub. Date: Aug. 26, 2010

(54) System and Methods for Supporting Multiple Communications Protocols on a Mobile Phone Device

(75) Inventors: Tung Chang, Saratoga, CA (US); Ruei-Shiang Suen, Dublin, CA (US); Andrea Chen, San Jose, CA (US); Baoguo Yang, San Jose, CA (US); Yue Chen, Fremont, CA (US)

Correspondence Address: Venture Pacific Law, PC, 5201 Great America Parkway, Suite 270, Santa Clara, CA, 95054, US

(73) Assignee: AUGUSTA TECHNOLOGY, INC., Santa Clara, CA (US)

(21) Appl. No.: 12/711,243

(22) Filed: Feb. 23, 2010

Related U.S. Application Data
(60) Provisional application No. 61/154,761, filed on Feb. 23, 2009.

(51) Int. Cl. H04W 88/06

(52) U.S. Cl. 455/552.1

(57) ABSTRACT

A mobile phone device utilizing a first communications protocol and a second communications protocol, comprises: a first system having a general processor, a memory, a first communications system providing for the first communications protocol and utilizing a first communications protocol stack, and a first link; a second system having a dedicated communications accelerator providing for the second communications protocol and utilizing a second communications protocol stack, and a second link; wherein the first link and the second link are connected; and wherein the memory in the first system holds the first communications protocol stack and the second communications protocol stack.

### CROSS REFERENCE

This application claims priority from a provisional patent application entitled “Systems and Methods for Managing and Sharing Resources of a Cellular Device for Various Communication Technologies” filed on Feb. 23, 2009 and having an Application No. 61/154,761. Said application is incorporated herein by reference.

### FIELD OF INVENTION

The present invention relates generally to wireless communications systems, and, more particularly, to systems and methods for supporting multiple communications protocols and sharing resources for the multiple communications protocols.

### BACKGROUND

One commonly used type of mobile telephone communications system is a Code Division Multiple Access (“CDMA”) system. In a CDMA system, radio signals share the same frequency spectrum at the same time, in contrast to a Frequency Division Multiple Access (“FDMA”) system or Time Division Multiple Access (“TDMA”) system. One current CDMA system is known as the second generation (“2G”) standard. More recently, third generation (“3G”) standards have been recently implemented, including GSM EDGE, UMTS, CDMA2000, DECT, WiMAX, and so forth. Various countries may adopt different 3G standards depending on their needs and infrastructure and may have different standard specific requirements. As more and more 3G standards are implemented and used, mobile phone systems will contain a mix of both older 2G standards and newer 3G standards.

In a typical CDMA communications system, a mobile station (e.g., a mobile phone device) communicates with a base station having the strongest available signal. In order to track the available signals, the mobile station maintains a list of available base stations. Specifically, each base station in the CDMA system transmits an unmodulated “pilot” signal on a set of predetermined frequencies. A mobile station receives the pilot signals and determines which pilot signals are the strongest. A “searcher” unit located in the mobile station commonly performs the signal detection and strength measurement functions.

The results from the searcher are reported to the current (i.e. active) base station. The base station then instructs the mobile station to update a list of available base stations maintained by the mobile station. The list is sub-divided into three operative sets—an active set, a candidate set, and a neighbor set. The active set contains a list of the base stations with which the mobile station is currently communicating (typically 1-4 base stations). The candidate set is a list of base stations which may move into the active set, and the neighbor set is a list of base stations which are being monitored, but less frequently.

As the mobile station moves and its currently active base station signal weakens, the mobile station must access a new base station. Based upon the results of the searcher, and the instructions received back from the base station, the mobile station will update its sets, and communicate with a different base station. In order for communications transmissions to appear seamless to the user of the mobile station, the communications link must be handed off to the next base station. Ideally, this handoff establishes a new link before terminating the first link.

A hand off between two different generations of CDMA systems can be very problematic and result in data transmission interruption and even drop calls. For instance, most 3G standards have been designed to provide backward compatibility with a 2G standard at the signaling and call processing level. However, since these two types of standards employ different modulation schemes, spreading rates, and specification requirements, they are not naturally compatible at the physical layer.

The major functional parts for both a 2G communications standard and a 3G communications standard may be similar. Each 2G and 3G communications standards have respective protocol stack processing, baseband processing, and radio functions. From a physical layout perspective, traditionally the 2G and 3G communications systems have respective sets of (1) memory to hold software programs and data, (2) processors to run protocol stack software and baseband software, and (3) a radio for over the air communications.

Presently, one of the solutions for the handover problem has been to include hardware and software components for a 2G communications standard and for a 3G communications standard on a mobile phone device, and then synchronize between the 2G system and 3G system. For instance, FIG. 1 illustrates a prior art system for a mobile phone device, where each communications sub-system has an individual processing core, a link to a system memory, RF transceiver, and possibly internal registers. Here, a 2G sub-system has a memory 2, a 2G processing core 4 comprising an application processor, a 2G baseband processor, a 2G stack processor, a multimedia processor, a Bluetooth processor, a mobile TV processor, or other processors, internal registers controlled by the 2G processing core, an audio CODEC module 6, and a 2G radio frequency (“RF”) transceiver 8. In addition, a 3G sub-system is also included in the mobile phone device with its own link to a system memory 10, 3G processing core 12, internal registers controlled by the 3G processing core 12, an audio CODEC module 14, and a 3G RF transceiver 16.

Subsequently, the above mentioned prior art system can be quite costly since each communications sub-system requires separate processing cores, radios, and links to the system memory. In addition, synchronizing the two processing cores for a seamless handover can be very difficult. Therefore, it is desirable to provide systems and methods for sharing the resources between two or more communications sub-systems (e.g., a 2G communications system and a 3G communications system or multiple 3G communications standards).

Another solution has been to couple a 2G communications sub-system and a 3G communications sub-system on a single chip. However, as noted above, 3G communications systems are a family of standards such that in order to accommodate each 3G standard the single chip would have to be redesigned according to the specific requirements of each standard since each standard may have different hardware and software requirements. Thus, it would be costly and inconvenient to redesign the single chip to handle a specific 3G standard or other future standards. Therefore, it is desirable to provide systems and methods for a communications system that can conveniently and cost efficiently interchange or add various communications standard specific hardware and software to support additional communications standards.

### SUMMARY OF INVENTION

An object of this invention is to provide a communications system for a multi-mode mobile phone device that supports automatic and seamless handover between multiple communications standards (e.g., between a 2G standard and a 3G standard).

Another object of this invention is to provide a communications system that can support additional communications standards by connecting a dedicated accelerator for a particular communications standard via a point to point interface.

Yet another object of this invention is to provide a communications system that shares a common processing core to control and run various communications protocols.

Furthermore, another object of this invention is to provide a method for a point to point interface to interface a general processor with a dedicated accelerator for a particular communications standard to support resource sharing and control of the dedicated accelerator.

Briefly, a mobile phone device utilizing a first communications protocol and a second communications protocol, comprises: a first system having a general processor, a memory, a first communications system providing for the first communications protocol and utilizing a first communications protocol stack, and a first link; a second system having a dedicated communications accelerator providing for the second communications protocol and utilizing a second communications protocol stack, and a second link; wherein the first link and the second link are connected; and wherein the memory in the first system holds the first communications protocol stack and the second communications protocol stack.

An advantage of this invention is that a communications system for a multi-mode mobile phone device that supports automatic and seamless handover between multiple communications standards (e.g., between a 2G standard and a 3G standard) is provided.

Another advantage of this invention is that a communications system that can support additional communications standards by connecting a dedicated accelerator for a particular communications standard via a point to point interface is provided.

Yet another advantage of this invention is that a communications system that shares a common processing core to control and run various communications protocols is provided.

Furthermore, another advantage of this invention is that a method for a point to point interface to connect a general processor with a dedicated accelerator for a particular communications standard to support resource sharing and control of the dedicated accelerator is provided.

### DESCRIPTION OF THE DRAWINGS

The foregoing and other objects, aspects, and advantages of the invention will be better understood from the following detailed description of the preferred embodiment of the invention when taken in conjunction with the accompanying drawings in which:

FIG. 1 illustrates a prior art system for a mobile phone device, where each communications sub-system has an individual processing core, a link to a system memory, RF transceiver, and possibly internal registers.

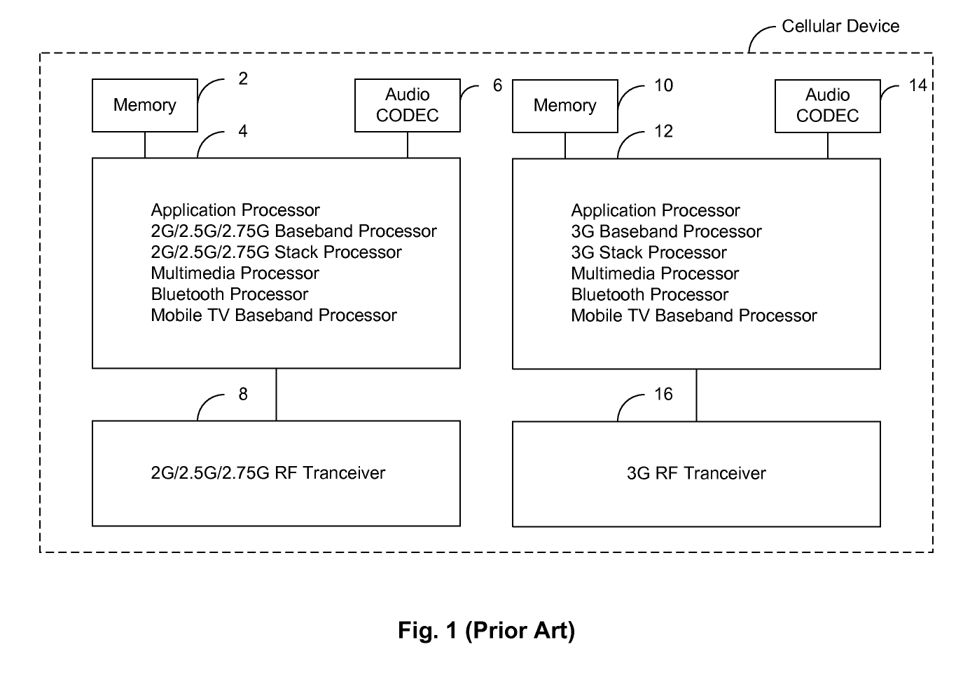

FIG. 2 illustrates an embodiment of the present invention for a mobile phone device, where a processing core and memory are shared by a 2G system and a 3G system via a point to point (“p-to-p”) interface.

FIG. 3 illustrates an embodiment of the present invention for a memory interface to enable various components of the 2G system and the 3G system to share system memory.

FIG. 4 illustrates a data stream of the present invention for a serial interface write command via a DIO.

FIG. 5 illustrates a data stream of the present invention for a serial interface read command via a DIO.

FIG. 6 illustrates a serial interface data stream and parallel interface data stream for a read or write command over several DIOs.

FIG. 7 illustrates a timing sequence of the present invention for the CLK, output signal, and input signal over the DIOs of the serial and parallel interfaces.

### DETAILED DESCRIPTION OF THE PREFERRED EMBODIMENTS

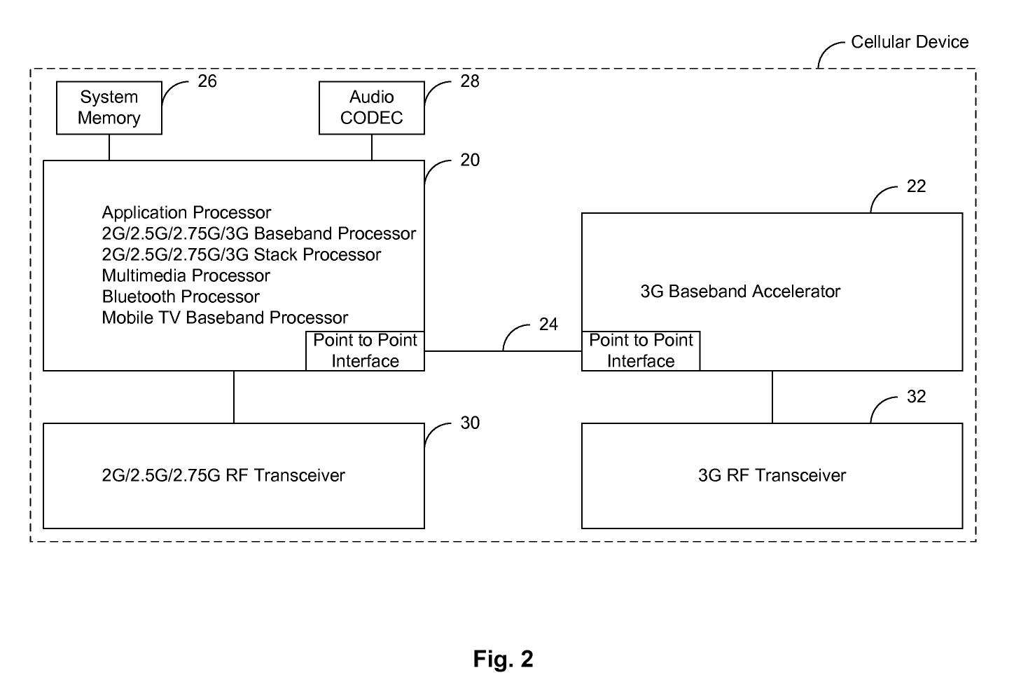

FIG. 2 illustrates an embodiment of the present invention for a mobile phone device, where a processing core and memory are shared by a 2G sub-system and a 3G sub-system via a point to point (“p-to-p”) interface. A processing core 20 (which can be referred to as a general processor), comprising a stack processor and a baseband processor, is connected to a dedicated communications accelerator 22 for a specific 3G standard (which can be referred to as a 3G accelerator) via a point to point interface 24 to support a 3G communications system. The hardware requirements for the 3G accelerator 22 can be specific to a particular 3G standard. Furthermore, the processing core 20 can be linked to one or more 3G accelerators, where each of the 3G accelerators can be dedicated accelerators to implement a specific 3G standard. It can be appreciated that other accelerators dedicated to current and future communications technologies can be connected via the point to point interface 24 to support the current and future communications technologies.

In addition, each of the communications sub-systems can have a dedicated RF transceiver for transmitting and receiving signals in accordance with the respective communications standard. Thus, a RF transceiver 30 can receive a signal according to a 2×G communications standard and a RF transceiver 32 can receive a signal according to a 3G communications standard.

The dedicated 3G accelerator 22 can be hardware designed to efficiently carry out specific algorithms in accordance with its respective 3G standard. The 3G accelerator 22 may be coupled to a digital signal processing (“DSP”) module (not shown), where the DSP module can perform less demanding computationally-intensive tasks of pre-processing and post-processing data.

In general, an accelerator is specifically designed and tied to a particular communications standard. An accelerator for a 3G communications standard may support echo cancellation, voice recognition, audio and video compression, error correction coding, data encryption and scrambling, transmit signal modulation and filtering, demodulation, descrambling, decryption, decoding, decompression of received signals, and so forth. Since various 3G standards vary in specification requirements, several accelerators can be used in conjunction with the processing core 20 via the point to point interface 24 for operating each of the various communications standards by the processing core 20.

The processing core 20 can further comprise an application processor, a multimedia processor, a Bluetooth processor, a mobile TV baseband processor, or other processors. The processing core 20 can process the 2G sub-system's (or other 2G variations such as 2.5 G, 2.75 G, etc. and can generally be referred to as 2×G) communications protocols and protocol stacks and the 3G system's communications protocols and protocol stacks. Since the communications protocols and protocol stacks are mainly software driven, software specific to the 2G sub-system can be swapped with software specific to the 3G sub-system when needed, and vice versa. Alternatively, the protocols and stacks can be simultaneously processed. The processing core 20 can also write to and read from internal registers of the 3G accelerator 22 (not shown) as well as its own internal registers in the processing core 20 (not shown). Thus, the processing core 20 can support the 2G sub-system and 3G sub-system in an efficient and cost effective manner.

The processing core 20 can directly access the system memory 26, while the baseband accelerator 22 can access the system memory 26 via the point to point interface 24. The system memory 26 can also be shared by a number of other accelerators connected via the point to point interface 24, which can greatly save on platform cost since each accelerator does not have to have a direct link to the system memory 26. The system memory 26 can be either volatile memory (e.g., Mobile RAM) and/or nonvolatile (e.g., NAND memory).

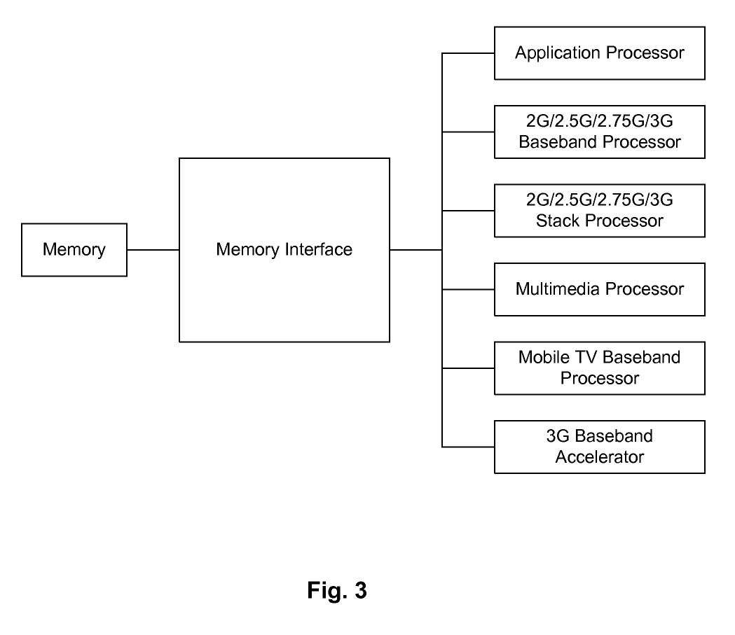

Furthermore, system memory 26 can be accessed by the 3G accelerator 22 via the proprietary p-to-p interface 24 (and/or via a memory interface, where the memory interface is illustrated in FIG. 3). The memory interface can be a logic block located in the processing core 20. The memory interface generally arbitrates memory access for the various processors within the processing core 20 and the 3G accelerator 22. The p-to-p interface 24 provides data transfer between the processing core 20 and the 3G accelerator 22 for accessing the system memory 26 and the internal memory of the processing core 20 and the 3G accelerator 22.

To aid in the understanding of the invention, the processing core 20 can be referred to as the master and the 3G accelerator can be referred to as the slave since the processing core 20 (e.g., a master processor) controls the 3G accelerator 22 (e.g., a slave processor).

The p-to-p interface 24 supports at least two kinds of data flow: (1) high bandwidth, high throughput data flow; and (2) a low bandwidth data flow. The specific signals across these two types of data flows can be determined by the respective 2G and 3G standards for the physical behavior of the 2G sub-system and the 3G sub-system, wherein these standards are incorporated herein by reference. Generally, the two kinds of data flow can contain computation results exchanged between the processing core 20 and the 3G accelerator, as well as data to and from the system memory 26, the internal memory of the processing core 20, and the registers of the 3G accelerator.

In an embodiment of the present invention, a serial interface can be implemented to provide a low bandwidth data flow. Furthermore, a parallel interface can be implemented to provide a high bandwidth, high throughput data flow.

The serial interface can be mainly used for writing or reading slave registers on the 3G accelerator 22. The interface uses a bidirectional digital input/output (“DIO”) signal together with a clock signal. Both the master and the slave can initialize the DIO signal as an input. The master can provide a weak resistive pull down to 0V (with a nominal value 50 k Ohm) on the DIO line.

Each transaction on the serial interface can be either a register write or a register read. A write transaction consists of an address and data packet driven by the master, and then followed by a response packet driven by the slave. A read transaction consists of an address packet driven by the master, and a response and data packet driven by the slave.

In a preferred embodiment of the invention, the master can allocate a minimum of two clock cycles between consecutive serial interface transactions in accordance to a serial interface protocol. The serial interface protocol may not define the length of address field and data field, but can be limited to 32 bits each. Furthermore, the serial interface protocol may not define the serial order (most significant bit or least significant bit first) of the address/data field, which can be implementation dependent.

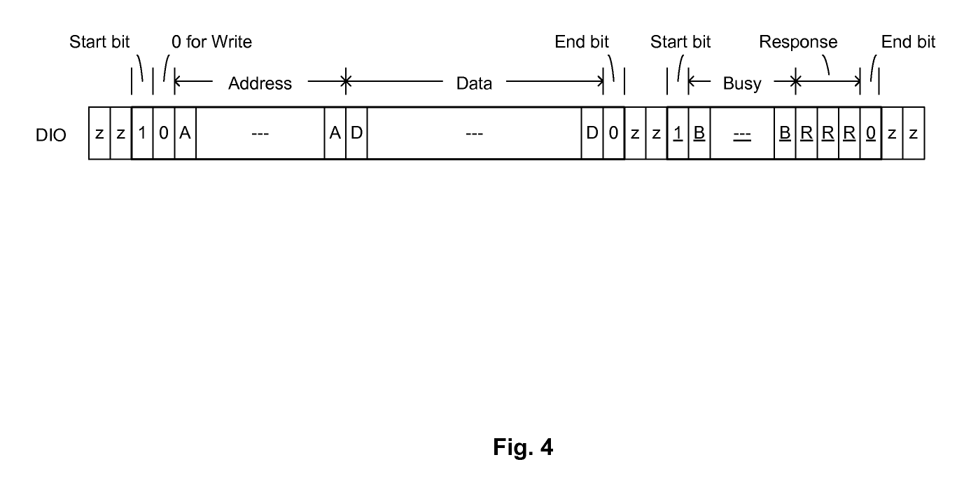

FIG. 4 illustrates a data stream of the present invention for a serial interface write command via a DIO. To initiate a write transaction on the serial interface, the master can start by driving a ONE signal in a single cycle on the DIO line to indicate the start of the address and data packet, then driving a ZERO signal to indicate a write operation; N_{addr} cycles of the address field (“A”) and N_{data} cycles of data field (“D”) can follow. The master drives a ZERO signal after the data field to indicate the end of the packet.

After at least two cycles (“Z”) have passed to account for a bus turn around time, the slave sends a response packet. The response packet is framed by a start bit, followed by zero or more busy bits (“B”), and then followed by the 3-bit response (“R”) and the end bit. The slave drives the busy bit when it is not able to process the write transaction in time. The encoding of the 3-bit response can be “000” for an okay response or a “001” to indicate an error (e.g., the write command is to a non-defined address). It is appreciated by a person having ordinary skill in the art that other implementations can be used for a serial interface write.

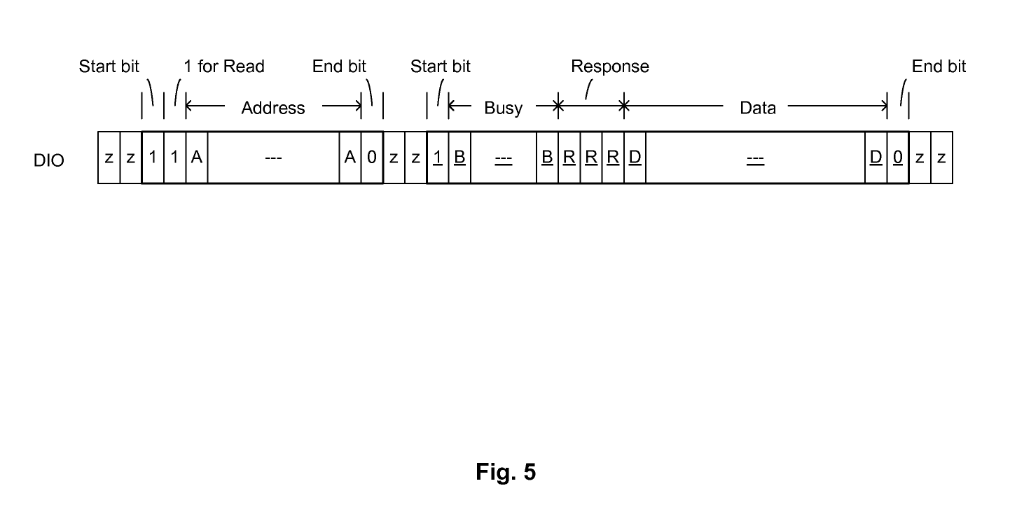

FIG. 5 illustrates a data stream of the present invention for a serial interface read command via a DIO. To initiate a serial interface read, the master drives a start bit, next a read indicator bit, then a N_{addr} address field, and lastly an end bit. After two cycles to account for a bus turn around time, the slave drives a start bit, zero or more busy bits, the 3-bit response, the N_{data} data field, and the end bit. The slave drives the busy bit until it is able to return the response and data. The encoding of the 3-bit response can be “000” to indicate an okay status or a “001” to indicate an error status (e.g., read from non-defined address). In case of an error response, the slave can still drive N_{data} cycles of the data field, where the content of the data field can be arbitrary. It is appreciated by a person having ordinary skill in the art that other implementations can be used for a serial interface read.

Thus, for each transaction on the serial interface takes a minimum of 2 (cycles between transactions)+1 (start bit)+1 (read/write)+N_{addr}+1 (end bit)+2 (bus turn around)+1 (start bit)+3 (response)+1 (end bit)+N_{data}=12 +N_{addr}+N_{data} cycles. Assuming the number of cycles for the address is N_{addr}=16, the number of cycles for the data is N_{data}=32, and a 52 MHz clock is used, the minimum duration for one transaction is around 60/52=1.15 usec.

The maximum frequency of the clock (“CLK”) can be 52 MHz, where the clock is typically driven by the master. The master may stop the clock whenever there is no traffic between the master and the slave. It is the master's responsibility to make sure that all transfers have been completed before stopping the clock. Both a serial interface and a parallel interface can use the same clock. The clock CLK can be divided down from the master core clock, which is generally the same as a local bus clock.

In an embodiment of the present invention, to access the slave registers through the serial interface efficiently, the slave registers can be memory mapped to the master's address space in a paged fashion. The slave registers are transparent to the master since the master can operate the slave registers and its internal memory by a common address space. This mapping can be a one-to-one correspondence between the common address space and the slave's address space. Thus, when data is written to an address space belonging to the slave, the software interface can send that data automatically to the slave by translating the address to the slave's address space (e.g., in a single operation), and vice versa for a read command. Overall, the number of transactions by the master is reduced since it can write directly to the slave's registers.

In yet another embodiment of the present invention, in order to access the serial interface efficiently, the master can contain an N-entry command queue to allow the software to set up at most N serial interface transactions at one time. An interrupt can be issued after all programmed transactions have been completed.

The maximum length of the address field can be set to 32 bits, where the address comprises a 4-bit page address followed by 28-bit offset. To access a slave_address[31:0] on the slave, the software must program a slave_address[31:28] on a serial interface page register, and program a slave_address[27:0] to a serial interface address register. The master can be programmed to send only the useful part of a slave_address on the serial bus. If the total address space of the slave is 16 KB, and the registers are addressed at 32-bit (4-byte) boundaries, only a slave_address[13:2] needs to be transmitted on the address field.

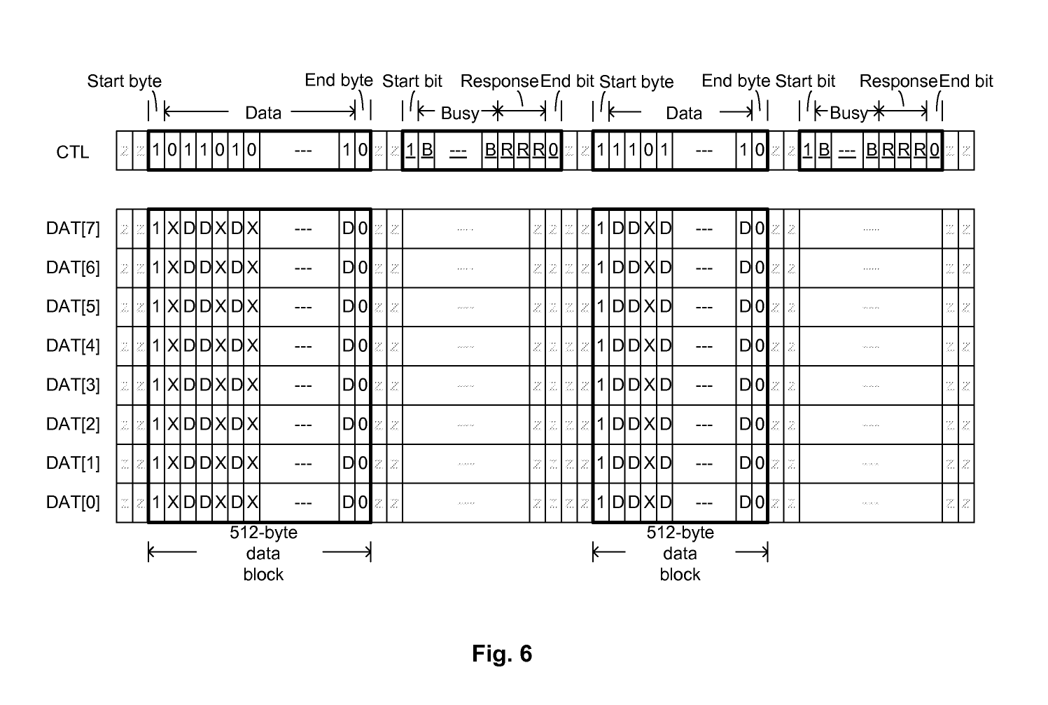

FIG. 6 illustrates a parallel interface data stream for a read or write command. A parallel interface can be used mainly for large volume data transfer, e.g., data may be sent from the master to the slave or from the slave to the master. The software on the master can initiate the data transfer. If the data is to be sent from the master to the slave, the master programs the source address and transfer size to the master registers, programs the destination address and transfer size to the slave registers, and then writes a master register to start the transaction. If the data is to be sent from the slave to the master, the master programs the source address and transfer size to the slave registers, programs the destination address and transfer size to the master registers, and then writes a slave register to start the transaction.

The parallel interface can use the same clock as the serial interface. The data can be transferred on parallel channels DAT[7] to DAT[0] synchronously according to the CLK. The source and destination address are byte aligned, where the basic unit of data transfer can be a byte. Data is transferred in blocks of 512 bytes, except the last block which can contain the residual number of bytes. Each block is framed by a start indicator and end indicators on channels DAT[7] to DAT[0] and CTL. Immediately following the start indicator, the source of the transfer (the sender) drives the data on the data channels DAT[7] to DAT[0] as well as a valid bit on the CTL channel. Data may or may not be presented in contiguous cycles. During the cycles where data is not valid, the sender drives 0 on the CTL channel and an arbitrary pattern on the data channels DAT[7] to DAT[0]. The cycle right after the start indicator must be a valid data cycle. The end indicator must follow the last byte of valid data immediately.

After the sender sends the end indicator of a block, the receiver can return a response after two cycles on the CTL line. The response is composed of a start bit, zero or more busy bits, the 3-bit response field, and an end bit. The receiver asserts the busy bit until it is able to accept subsequent block transfers. The sender should wait until the busy bit is no longer asserted and a proper response is received. Next, a minimum of two cycles to account for turn around time is waited before sending the next block.

The encoding of the 3-bit response can be indicated by “000” for an okay status or “001” for an error status (e.g., when the destination is at non-defined address). In case of an error response, data transfer should still continue until programmed number of bytes is transferred.

The master (which could be the sender or the receiver) should count the data transfer in either direction and keep the interface clock CLK running until the programmed number of bytes are sent or received. The master H/W generates an interrupt after the parallel interface transfer is completed.

Thus, the maximum throughput of the parallel interface, taking the framing overhead into account is 52 Mbyte/sec*512/(512+1 (start byte)+1 (end byte)+2 (turn around time)+1 (start bit)+3 (response bits)+1 (end bit)+2 (turn around))=50.9 Mbyte/sec.

Additionally, the serial interface and the parallel interface can be active at the same time, i.e., a large volume of data can be transferred while the master reads/writes registers on the slave through the serial interface.

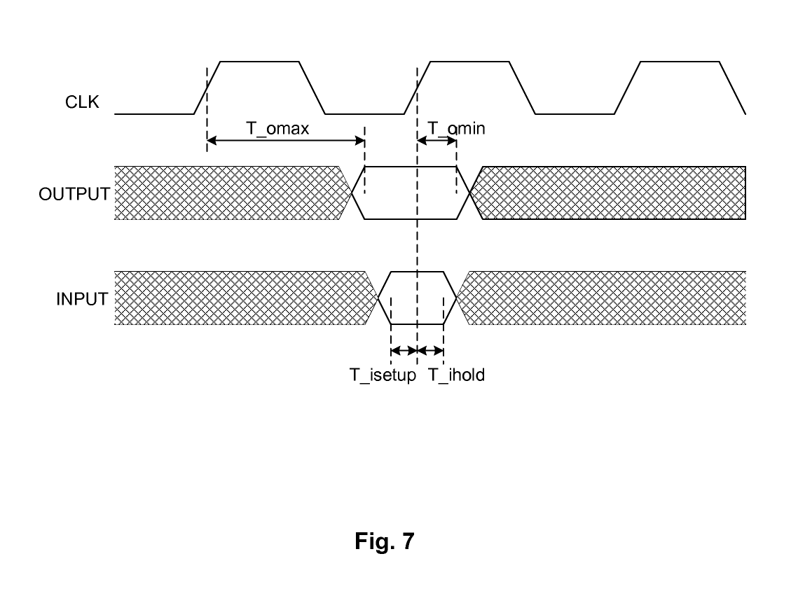

FIG. 7 illustrates a timing sequence of the present invention for the CLK, output, and input signals of the serial and parallel interfaces. A T_omax time can be a maximum delay for the output; a T_omin can be the minimum delay for the output; a T_isetup can be the setup time for the input; and a T_ihold can be the hold time for the input.

While the present invention has been described with reference to certain preferred embodiments or methods, it is to be understood that the present invention is not limited to such specific embodiments or methods. Rather, it is the inventor's contention that the invention be understood and construed in its broadest meaning as reflected by the following claims. Thus, these claims are to be understood as incorporating not only the preferred methods described herein but all those other and further alterations and modifications as would be apparent to those of ordinary skilled in the art.

We claim:

1. A mobile phone device utilizing a first communications protocol and a second communications protocol, comprising:
a first system having
a general processor,
a memory,
a first communications system providing for said first communications protocol and utilizing a first communications protocol stack, and
a first link; and
a second system having
a dedicated communications accelerator providing for said second communications protocol and utilizing a second communications protocol stack, and
a second link,
wherein the first link and the second link are connected, and wherein the memory in said first system holds the first communications protocol stack and the second communications protocol stack.

2. The device of claim 1 wherein said second system having a plurality of registers for receiving commands from said first system via said first link and said second link.

3. The device of claim 1 wherein said second system having a plurality of registers for transferring data to and from said first system via said first link and said second link.

4. The device of claim 1 wherein each of the first link and the second link comprises a serial link and a parallel link.

5. The device of claim 1 wherein the second system utilizes the memory of the first system via the first link and the second link.

6. The device of claim 1 wherein the second system has a plurality of registers and these registers are accessible by the first system through a range of pre-defined addresses and via the first link and the second link.

7. The device of claim 6 wherein the registers are accessible by the first system in one single operation.

8. A mobile phone device utilizing a first communications protocol and a second communications protocol, comprising:
a first system having
a general processor,
a memory,
a first communications system providing for said first communications protocol and utilizing a first communications protocol stack, and
a first link; and
a second system having
a dedicated communications accelerator providing for said second communications protocol and utilizing a second communications protocol stack, and
a second link,
wherein the first link and the second link are connected, wherein the memory in said first system holds the first communications protocol stack and the second communications protocol stack, wherein said second system having a plurality of registers for receiving commands from said first system via said first link and said second link, and wherein the second system utilizes the memory of the first system via the first link and the second link.

9. The device of claim 8 wherein the plurality of registers are able to transfer data to and from said first system via said first link and said second link.

10. The device of claim 8 wherein each of the first link and the second link comprises a serial link and a parallel link.

11. The device of claim 8 wherein the plurality of registers are accessible by the first system through a range of pre-defined addresses and via the first link and the second link.

12. The device of claim 11 wherein the registers are accessible by the first system in one single operation.

13. A mobile phone device utilizing a first communications protocol and a second communications protocol, comprising:
a first system having
a general processor,
a memory,
a first communications system providing for said first communications protocol and utilizing a first communications protocol stack, and
a first link; and
a second system having
a dedicated communications accelerator providing for said second communications protocol and utilizing a second communications protocol stack, and
a second link,
wherein the first link and the second link are connected, wherein the memory in said first system holds the first communications protocol stack and the second communications protocol stack, wherein said second system having a plurality of registers for receiving commands from said first system via said first link and said second link and for transferring data to and from said first system via said first link and said second link, wherein each of the first link and the second link comprises a serial link and a parallel link, and wherein the second system utilizes the memory of the first system via the first link and the second link.

14. The device of claim 13 wherein the plurality of registers are accessible by the first system through a range of pre-defined addresses and via the first link and the second link.

15. The device of claim 14 wherein the registers are accessible by the first system in one single operation.
